(19) United States
(12) Patent Application Publication
(10) Pub. No.: US 2004/0107359 A1
(43) Pub. Date: Jun. 3, 2004

(54) Utilizing the suspend state of an information handling system

(75) Inventors: Seiichi Kawano, Sagamihara (JP); Kenji Oka, Yokohama-shi (JP); Kishiko Itoh, Tokyo (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/678,624

(22) Filed: Oct. 3, 2003

(30) Foreign Application Priority Data
Oct. 3, 2002 (JP) 2002-291718

(51) Int. Cl. G06F 12/14

(52) U.S. Cl. 713/200

(57) ABSTRACT

A robust information processing apparatus that prevents damage to an executable program for an OS due to an unintended operation by a user is provided. The apparatus includes an external storage device having a normal partition that can be referred to by a user and a hidden partition storing an executable program for an operating system and hidden from the user, a reading portion that reads the executable program for the operating system from the hidden partition to a main storage unit, and an execution portion that executes the operating system read into the main storage unit.

### BACKGROUND of the INVENTION

The present invention relates to an information processing apparatus, a control method, a program and a recording medium. More particularly, the present invention relates to an information processing apparatus which controls the way to activate an operating system, a control method, a program and a recording medium.

Information processing apparatuses in which switching between a plurality of operating systems is performed in such a manner that each operating system switches between an operating state and a suspended state (patent document 1, patent document 2, and patent document 3).

(Patent Document 1)

Published Unexamined Patent Application No. 2001-256066

(Patent Document 2)

Published Unexamined Patent Application No. 11-288366

(Patent Document 3)

Published Unexamined Patent Application No. 10-63362

In the information processing apparatuses disclosed in the documents shown above, however, it is possible that in some case areas in an external storage device in which programs to be executed by a second operating system are stored can be accessed by using a first operating system. Therefore, there is a risk of a program to be executed by the second operating system being broken by an inadvertent user operation or by program processing with malicious intent on the first operating system.

It is a purpose of the present invention to provide an information processing apparatus, a control method, a program and a recording medium capable of solving the above-described problem. This purpose can be attained by a combination of the features described in the independent claims in the appended claims, and further advantageous examples of the present invention are specified in the dependent claims.

### SUMMARY OF THE INVENTION

According to a first aspect of the present invention, there are provided an information processing apparatus including an external storage device having a normal partition that can be referred to by a user and a hidden partition storing an executable program for an operating system and hidden from the user, a reading portion that reads the executable program for the operating system from the hidden partition to a main storage unit in response to a direction for reading the program from the user, and an execution portion that executes the operating system read into the main storage unit, a control method of controlling the information processing apparatus, a program for realizing the information processing apparatus, and a recording medium on which the program is recorded.

The above-described outline of the present invention does not cover the entire list of the necessary features of the present invention, and subcombinations of the features may constitute the present invention.

### BRIEF DESCRIPTION OF THE DRAWINGS

Some of the purposes of the invention having been stated, others will appear as the description proceeds, when taken in connection with the accompanying drawings, in which:

FIG. 1 is a functional block diagram of an information processing apparatus 10 in an embodiment;

FIG. 2 is a diagram showing the flow of operation of the information processing apparatus 10 in the embodiment;

FIG. 3 is a diagram showing details the flow of operation with respect to securing of the save area (S110);

FIG. 4 is a state transition diagram of the information processing apparatus 10;

FIG. 5 is a functional block diagram of an information processing apparatus 10 in a first example of modification;

FIG. 6 is a diagram showing details the flow of operation with respect to securing of the save area (S1 10) in the first example of modification;

FIG. 7 is a functional block diagram of an information processing apparatus 10 in a second example of modification;

FIG. 8 is a diagram showing details the flow of operation with respect to securing of the save area (S1 10) in the second example of modification;

FIG. 9 is a functional block diagram of an information processing apparatus 10 in a third example of modification;

FIG. 10 is a diagram showing the flow of operation of the information processing apparatus 10 in the third example of modification; and

FIG. 11 is a diagram showing an example of the hardware configuration of the information processing apparatus 10 in the embodiment of the present invention and the examples of modification.

### DETAILED DESCRIPTION of the ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

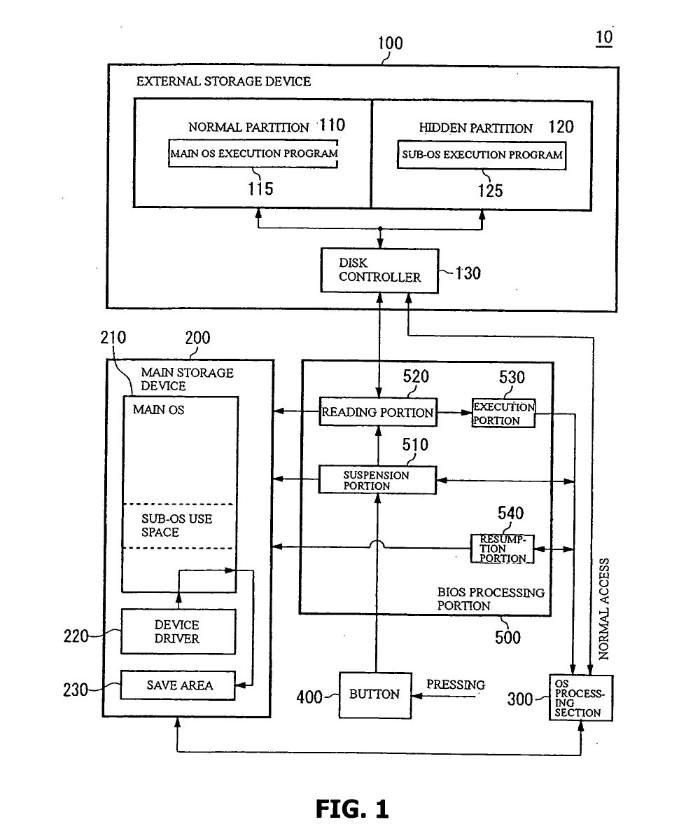

Referring now more particularly to the accompanying drawings, FIG. 1 is a functional block diagram of an information processing apparatus 10 in this embodiment. The information processing apparatus 10 has an external storage device 100 having a storage area not mapped at addresses in a main storage device 200, the main storage device 200, an OS processing portion 300 for making operating systems (hereinafter referred to as OSs) operate, a button 400 for accepting a pressing operation from a user, and an BIOS processing portion 500 which executes a BIOS program stored in a ROM or the like. In this embodiment, OSs are programs which enable various devices provided in the information processing apparatus 10, e.g., input/output devices and the external storage device to perform function. For example, each OS may include a kernel program for realizing basic operations of the OS, and a device driver for controlling each of the input/output devices.

The external storage device 100 stores in advance a sub-OS having a starting time shorter than that of a main OS and having a power consumption lower than that of the main OS in a hidden partition 120 which cannot be referred to from the main OS managing ordinary operations in the information processing apparatus 10. When the BIOS processing portion 500 receives a direction for switching from the main OS to the sub-OS from a user through the button 400, it interrupts the execution of the main OS, saves the state of execution of the main OS in the main storage device 200 to a save area 230, and reads out the sub-OS from the hidden partition 120 to the main storage device 200 to execute the sub-OS. When the operation of the sub-OS is finished, the BIOS processing portion 500 recovers the executed state of the main OS from the save area 230 and resumes execution of the main OS.

In the information processing apparatus 10, as described above, the sub-OS is stored in the hidden partition 120 which cannot be referred to by a user using the main OS, thereby preventing a program executed by the sub-OS from being damaged by an operation inadvertently performed by the user. The information processing apparatus 10 can start the sub-OS having a starting time shorter than that of the main OS and having a power consumption lower than that of the main OS when the main OS is in a suspended state and, therefore, can speedily perform, with high efficiency, information processing for which startup of the main OS is not required.

The starting time of each OS is a period of time from a moment at which the information processing apparatus 10 receives from a user a direction to read a file to be executed by the OS from the external storage device 100 to the main storage device 200, to a moment at which use of the OS by the user becomes possible. The time period to the moment at which use of the OS by the user becomes possible may be a time period to a moment at which acceptance of a user's direction becomes possible, a time period to a moment at which an application program becomes able to display information by using the functions of the OS, or a time period to a moment at which execution of an application program according to a user's direction becomes possible.

The external storage device 100 has a normal partition 110 which can be referred to by a user, the hidden partition 120 hidden from the main OS, and a disk controller 130 which controls accessing to the normal partition 110 and accessing to the hidden partition 120. In the normal partition 110, a main OS execution program 115 for executing the main OS is stored. In the hidden partition 120, a sub-OS execution program 125 for executing the sub-OS is stored. For example, the hidden partition 120 may be an area hidden from each of the main OS and the sub-OS and accessible only from the BIOS processing portion 500, or an area hidden only from the main OS and accessible from each of the sub-OS and the BIOS processing portion 500.

The main OS is a general-purpose OS for executing various applications. For example, the main OS is an OS having comparatively high-performance functions such as WINDOWS®. The main OS manages input/output devices, etc., in cooperation with the OS processing portion 300 according to instructions from a user program, a device driver or the like when it is in an normal state without receiving a normal suspension instruction to temporarily stop operating and to stop supply of power to part of hardware, a switching instruction, or the like.

The sub-OS is an OS intended mainly to offer a particular service when the main OS is in the suspended state. The sub-OS may be a special-purpose OS for executing a particular application only. For example, the sub-OS may be a comparatively function-limited OS such as DOS, or a customized OS formed by removing part of the functions of Linux®. The sub-OS may have a reduced power consumption in comparison with the main OS since the sub-OS is limited in function in comparison with the main OS. For example, the information processing apparatus 10 may operate the CPU, etc., on the sub-OS at a clock frequency lower than that at which it operates the CPU, etc., on the main OS.

Also, when the sub-OS runs, the information processing apparatus 10 may operate by supplying power to a smaller number of hardware components or by using a smaller amount of memory.

When the information processor 10 receives a direction for switching, the sub-OS may operate only a particular piece of application software, e.g., PIM (Personal Information Manager) in an environment in which it is limited in function in comparison with the main OS.

The sub-OS execution program 125 may be program codes for executing the sub-OS or the state of execution of the sub-OS started in advance (e.g., a memory image including program codes and a stack area or the like).

In a normal state where the main OS runs, the disk controller 130 accesses the normal partition 110 according to a normal access instruction received from the OS processing portion 300. On the other hand, the disk controller 130 permits readout from the hidden partition 120 when receiving a predetermined password from the BIOS processing portion 500. The disk controller 130 returns to the OS processing portion 300 or to the BIOS processing portion 500 the results of accessing the normal partition 110 or the hidden partition 120 according to the instruction from the OS processing portion 300 or the BIOS processing portion 500.

The main storage device 200 has a main OS use space 210 used by the main OS executed by the OS processing portion 300 in the normal state, a device driver 220 executed on the main OS, and a save area 230 to which the state of execution of the main OS is saved.

In the main OS use space 210, the main OS execution program read out from the external storage device 100 by the OS processing portion 300 is stored.

For example, the main OS use space 210 includes a program for operating the main OS and a stack area or the like for the state of execution of the main OS.

Part of the memory space used as main OS use space 210 on the main storage device is used by the sub-OS when the main OS is in the suspended state.

The device driver 220 secures save area 230 by requesting the main OS to assign as save area 230 part of the main storage managed by the main storage device 200.

The save area 230 is an area which is assigned by the main OS receiving an instruction from the device driver 220, and which is not used from any of the main OS and user programs.

The OS processing portion 300 includes, for example, a central processing unit (CPU) or the like, and operates as the main OS by sequentially reading out from the main storage device 200 execution codes provided in the main OS use space 210. The OS processing portion 300 may access the normal partition 110 according to an instruction received from a user program or the like, and may perform communication with input/output devices by using the BIOS processing portion 500 or the like. For example, when the OS processing portion 300 secures save area 230 by the device driver 220, it sends to a suspend unit or suspension portion 510 information indicating the position of the save area 230 on the main storage device 200.

When the OS processing portion 300 receives an operation stop instruction for stopping the operation of the main OS from the suspension portion 510, it performs processing for stopping the operation of the main OS, i.e., processing for terminating programs necessary for the operation of the main OS, and sends to the suspension portion 510 an operation stop completion notice indicating the completion of suspension processing.

Also, the OS processing portion 300 executes the sub-OS read into the main storage device 200 according to a sub-OS execution instruction from an execution portion or unit 530. When the OS processing portion 300 completes the execution of the sub-OS, it sends a sub-OS execution completion notice to a resume unit or resumption portion 540. The OS processing portion 300 resumes the execution of the main OS restored in the main storage device 200 according to a main OS execution resumption instruction received from the resumption portion 540.

The button 400 comprises a plurality of buttons. In response to pressing of one of the buttons, a suspension instruction or a switching instruction is selected and transmitted to the suspension portion 510. The switching instruction comprises, for example, a save instruction to save the state of execution of the main OS to the save area 230 and a read instruction to read out the sub-OS execution program 125 from the hidden partition 120.

The button 400 may include a plurality of buttons or switches provided separately from a keyboard, or buttons or switches which accompany a keyboard. An input through a predetermined combination of keys in a keyboard may be recognized as pressing of a button.

The BIOS processing portion 500 has the suspension portion 510, a reader or reading portion 520, the execution portion 530, and the resumption portion 540.

When the suspension portion 510 accepts from a normal suspension instruction or a switching instruction from the button 400, it sends an operation stop instruction to the OS processing portion 300. The suspension portion 510 turns off the power to the input/output devices including the external storage device 100 if the instruction received from the button 400 is a normal suspension instruction, and if the suspension portion 510 receives an operation stop completion notice from the OS processing portion 300. Thereafter, when the suspension portion 510 receives from the button 400 an instruction to resume the operation of the main OS, it turns on the power to the input/output devices, etc., to resume the operation of the main OS.

For example, the suspension portion 510 makes the information processing apparatus 10 store information on the state of execution of the main OS in the main storage device 200 and enter the suspended state in which the supply of power to the input/output devices in the information processing apparatus 10 is stopped, while continuing the supply of power to the main storage device 200.

Another example of entering the suspended state is transition of the information processing apparatus 10 to a hibernation state such that the suspension portion 510 saves the state of execution of the main OS into the external storage device 100 and the supply of power to the main storage device 200 is stopped.

The suspension portion 510 saves the state of execution of the main OS in the main storage device 200 to the save area 230 at a position designated by the OS processing portion 300 if the instruction received from the button 400 is a switching instruction, and if the suspension portion 510 receives an operation stop completion notice from the OS processing portion 300. For example, the suspension portion 510 may save, to the save area 230, only data in the memory space to be used afterwards by the sub-OS in the memory space occupied by the main OS use space 210. In this case, if the memory space used by the sub-OS is smaller than the memory space used by the main OS, the suspension portion 510 can immediately perform processing for shifting the main OS into the suspended state and securing the area to be used by the sub-OS. When the suspension portion 510 completes saving of the state of execution of the main OS, it sends to the reading portion 520 a readout notice as an instruction to read out the sub-OS.

The arrangement may be such that when the suspension portion 510 executes the sub-OS by the reading portion 520 and the execution portion 530 when receiving a readout instruction from the button 400 after receiving a normal suspension instruction and stopping the operation of the main OS.

Conveniently, in such a case, a user can select and execute the main OS or the sub-OS according to the kind of information processing to be performed in the state where the operation of the main OS is stopped.

When the reading portion 520 receives a readout instruction from the suspension portion 510 in the suspended state in which the state of execution of the main OS is saved to the save area 230, it transmits to the disk controller 130 a predetermined password and an instruction to read out the sub-OS execution program 125. The reading portion 520 reads out the sub-OS execution program 125 from the hidden partition 120 to a predetermined area in the main storage device 200. The reading portion 520 then sends to the execution portion 530 a readout completion notice of the completion of readout of the sub-OS execution program 125 together with information required for execution of the sub-OS execution program 125, e.g., information indicating the address in the main storage device 200 from which the sub-OS execution program 125 has been read out.

The execution portion 530 receives the readout completion notice and information required for execution of the sub-OS execution program 125 from the reading portion 520, and sends the information required for execution of the sub-OS execution program 125 to the OS processing portion 300 together with a sub-OS execution instruction.

When the resumption portion 540 receives the sub-OS execution completion notice from the OS processing portion 300, it restores the state of execution of the main OS from the save area 230, and sends a main OS execution resumption instruction to the OS processing portion 300.

As described above, when the information processing apparatus 10 receives a direction for switching from a user, it stops the execution of the main OS and saves the state of execution of the main OS to the save area 230. Thereafter the information processing apparatus 10 can execute the sub-OS execution program 125 by reading it from the hidden partition 120 to the main storage device 200.

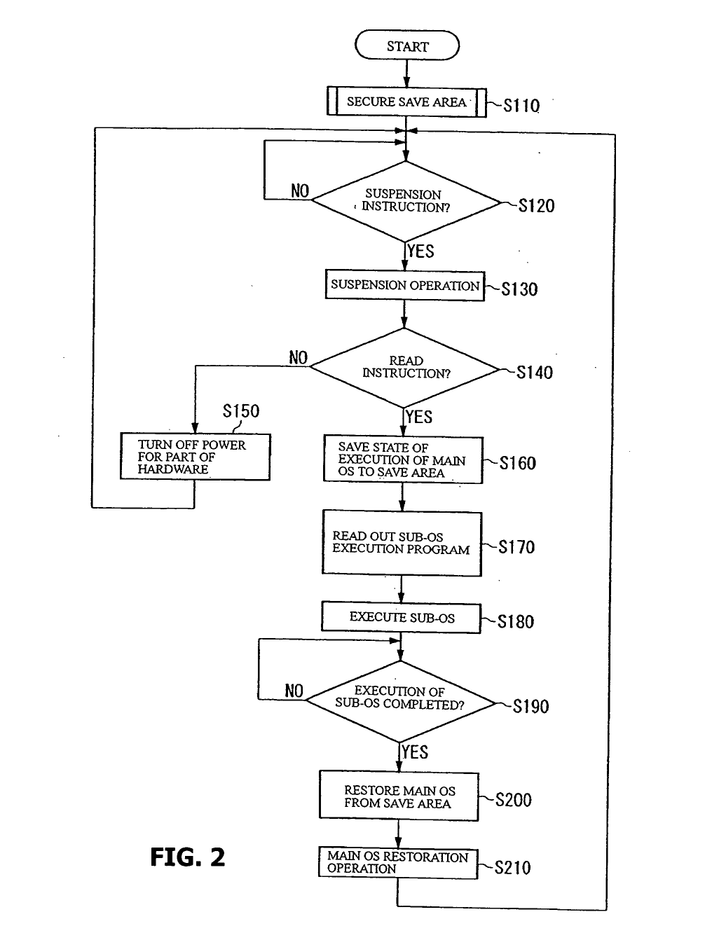

FIG. 2 is shows the flow of the operation of the information processing apparatus 10 in this embodiment. When the main OS is started in the information processing apparatus 10, the device driver 220 secure save area 230 by requesting the main OS to assign as save area 230 part of the main storage managed by the main storage device 200 (S110).

When the suspension portion 510 receives a suspension instruction such as a normal suspension instruction or a switching instruction (S120: YES), the OS processing portion 300 performs the suspension processing to stop the operation of the main OS (S130). If the suspension portion 510 does not receive any switching instruction including a readout instruction (S140: NO), it shuts off the supply of power to part of the hardware including the input/output devices (S150). Thereafter, the information processing apparatus 10 operates normally according to directions from a user, returns to step S120 and continues operating.

When the suspension portion 510 receives a switching instruction (S140: YES), it saves the state of execution of the main OS to the save area 230 (S160). The reading portion 520 then reads out the sub-OS execution program 125 from the hidden partition 120 to the predetermined area in the main storage device 200 (S170). The execution portion 530 initiates the execution of the sub-OS by making the OS processing portion 300 execute the sub-OS execution program 125 (S180).

When the OS processing portion 300 determines that the execution of the sub-OS is completed (S190: YES), the resumption portion 540 restores the state of execution of the main OS from the save area 230 (S200) and makes the OS processing portion 300 execute main OS restoration processing (S210).

The information processing apparatus 10 performs the ordinary operation on the main OS and returns to processing using the hidden partition 120.

As described above, when the main OS enters the suspended state, the information processing apparatus 10 can selectively perform shutting-off of the supply of power to part of the hardware or activation of the sub-OS according to a direction from a user.

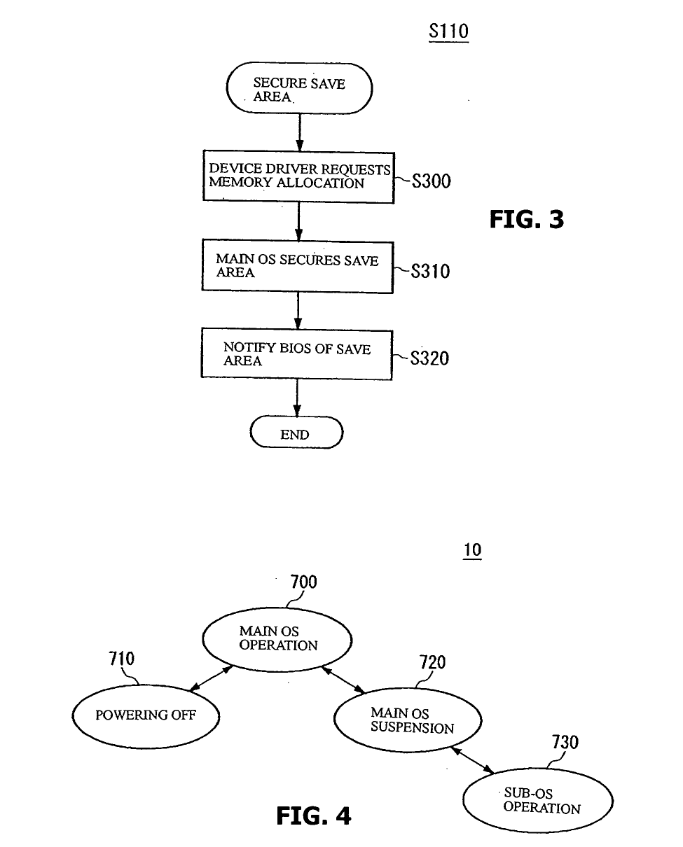

FIG. 3 shows in the flow of operation details of securing of the save area (S110). The device driver 220 requests the main OS to assign as save area 230 part of the main storage managed by the main storage device 200 (S300). At this request, the main OS secures the save area 230 (S310). For example, the device driver 220 may assign as save area 230 an area in the main storage device 200 on which a paging function or a swapping function provided on the main OS is not performed, or may assign save area 230 on the physical memory space without using any virtual storage function.

Subsequently, the OS processing portion 300 sends to the BIOS processing portion 500 information indicating the position of save area 230 in the main storage device 200 (S320). Therefore the BIOS processing portion 500 can correctly ascertain the position of save area 230 even after stoppage of the operations of the main OS and the device driver 220.

The arrangement may alternatively be such that the OS processing portion 300 does not send to the BIOS processing portion 500 information indicating the position of save area 230 in the main storage device 200. For example, in such a case, the device driver 220 may secure as save area 230 a predetermined area in the main storage device 200, and the suspension portion 510 may save the state of execution of the main OS by regarding the predetermined area as save area 230.

FIG. 4 is a state transition diagram of the information processing apparatus 10. The information processing apparatus 10 is in a power OFF state 710 in which the supply of power is shut off when it receives no starting instruction externally provided. When the information processing apparatus 10 receives a starting instruction externally provided, it enters a main OS operating state 700 in which it starts and executes the main OS. When the information processing apparatus 10 receives a normal suspension instruction or a switching instruction, it enters a main OS suspended state 720 in which the operation of the main OS is stopped.

If the received instruction externally provided is a switching instruction, the information processing apparatus 10 enters a sub-OS operating state 730 by starting the sub-OS. When the operation of the sub-OS ends, the information processing apparatus 10 returns to the main OS operating state 700 via the main OS suspended state 720.

If the received instruction externally provided is a normal suspension instruction, it shuts off the supply of power to part of the hardware. Thereafter, when the information processing apparatus 10 receives a main OS restoration instruction, it returns to the main OS operating state 700.

The information processing apparatus 10 may repeat state transition between the main OS operating state 700, the main OS suspended state 720, and the sub-OS operating state 730.

When the information processing apparatus 10 receives instruction to turn off the power, it returns to the power OFF state 710 and stops operating.

Thus, the information processing apparatus 10 can stop or resume the operations of the main OS and the sub-OS according to instruction externally provided, for example, from a user, and is, therefore, capable of realizing functions according to user's needs while adjusting the power consumption, starting time, etc.

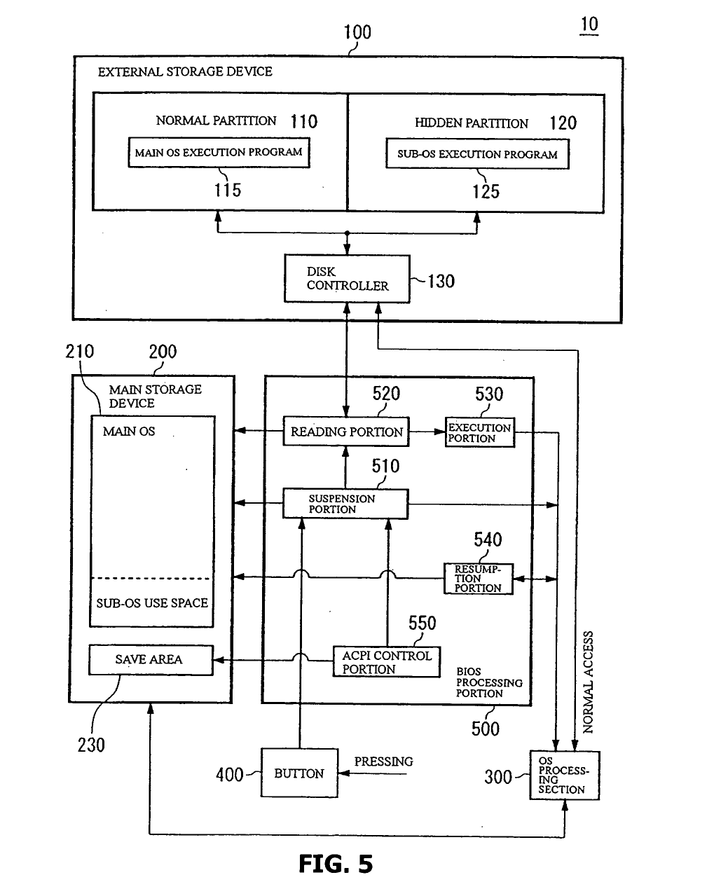

FIG. 5 is a functional block diagram of an information processing apparatus 10 in a first example of modification. The information processing apparatus 10 shown in FIG. 5 has such a configuration that an ACPI control portion 550 is added to the information processing apparatus 10 shown in FIG. 1. Unlike the information processing apparatus 10 shown in FIG. 1, the information processing apparatus 10 shown in FIG. 5 may be formed without the device driver 220. The operation of the information processing apparatus 10 shown in FIG. 5 is substantially the same as that of the information processing apparatus 10 shown in FIG. 1, and description will be made with respect to points of difference only.

When the information processing apparatus 10 is activated, the ACPI control portion 550 assigns, as save area 230 in the main storage device 200, an NVS (Non-Volatile-Sleeping) area which is a memory space used in ACPI (abbreviation of Advanced Configuration and Power Interface).

ACPI is a standard laid down by Intel Corporation, Microsoft Corporation and Toshiba Corporation as a standard of personal computer power management. The information processing apparatus 10 having the ACPI function can secure, in the main storage device 200, separately from the memory area used by the main OS, a work memory used for Non-Volatile-Sleeping operation by temporarily stopping the operation of the information processing apparatus 10, for example, at the time of startup of the information processing apparatus 10.

In this embodiment, the ACPI control portion 550 secures as save area 230 a work memory which can be secured by the ACPI function.

The ACPI control portion 550 sets a predetermined area in the NVS area as save area 230 and sends to the suspension portion 510 information indicating the position of this area in the main storage device 200. Receiving this information, the suspension portion 510 can save the state of execution of the main OS to the save area 230, which is the NVS area secured by using the ACPI function.

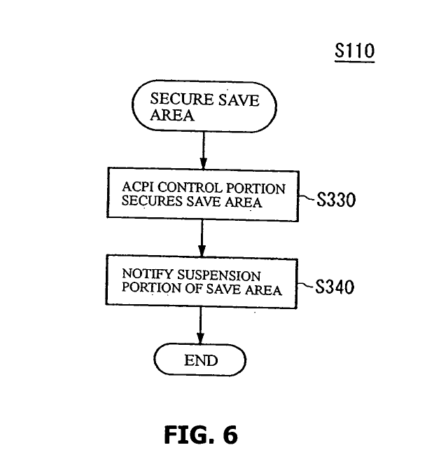

FIG. 6 shows in the flow of operation details of securing of the save area (S110) in the first example of modification. The flow of operation of the information processing apparatus 10 in this example of modification is substantially the same as the flow of operation of the information processing apparatus 10 shown in FIG. 2. Therefore description will be made with respect to different details of the operation.

The ACPI control portion 550 secures as save area 230 part of the NVS area secured by using the ACPI function (S330). The ACPI control portion 550 then sends to the suspension portion 510 information indicating the position of save area 230 in the main storage device 200 (S340).

Thus, the information processing apparatus 10 can secure, in advance, separately from the main OS use space 210, the save area 230 to which the state of execution of the main OS is saved.

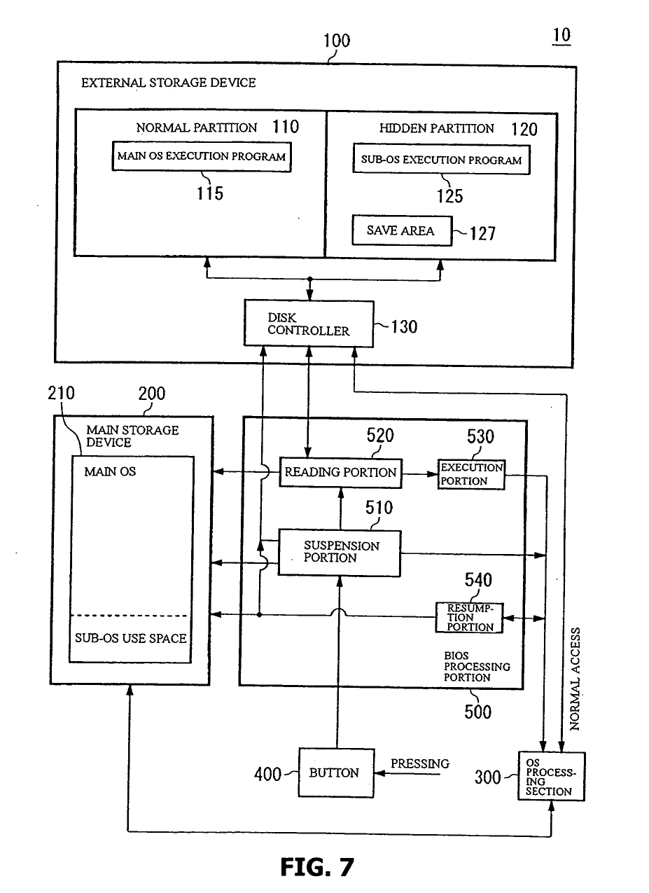

FIG. 7 is a functional block diagram of an information processing apparatus 10 in a second example of modification. The information processing apparatus 10 shown in FIG. 7 differs from the information processing apparatus 10 shown in FIG. 1 in that it has a save area 127 provided in the hidden partition 120 in place of save area 230. Unlike the information processing apparatus 10 shown in FIG. 1, the information processing apparatus 10 shown in FIG. 7 may be formed without the device driver 220. The operation of the information processing apparatus 10 shown in FIG. 7 is substantially the same as that of the information processing apparatus 10 shown in FIG. 1, and description will be made with respect to points of difference only.

The hidden partition 120 has save area 127 in addition to the sub-OS execution program 125 described above with reference to FIG. 1.

The suspension portion 510 holds in advance information on the position of save area 127 in the hidden partition 120, which information is set by an administrator, manufacturer or the like of the information processing apparatus 10. When the suspension portion 510 receives a switching instruction from the button 400 and also receives an operation stop completion notification from the OS processing portion 300, it saves the state of execution of the main OS in the main storage unit 200 to the save area 127 in the hidden partition 120. The suspension portion 510 then sends to the reading portion 520 a readout instruction which is an instruction to read out the sub-OS when saving of the state of execution of the main OS is completed.

When the resumption portion 540 receives a sub-OS execution completion notice from the OS processing portion 300, it restores the state of execution of the main OS from the save area 127 into the main storage device 200 and sends a main OS execution resumption instruction to the OS processing portion 300.

Thus, the suspension portion 510 saves the state of execution of the main OS to the hidden partition 120 and, therefore, the information processing apparatus 10 is capable of preventing the state of execution of the main OS from being inadvertently damaged during execution of the sub-OS.

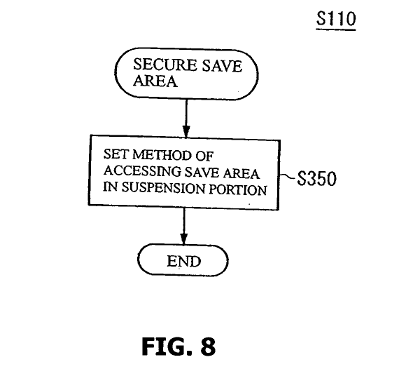

FIG. 8 shows in the flow of operation details of securing of the save area (S110) in the second example of modification. The flow of operation of the information processing apparatus 10 in this example of modification is substantially the same as the flow of operation of the information processing apparatus 10 shown in FIG. 2. Therefore description will be made with respect to different details of the operation.

The information processing apparatus 10 sets in the suspension portion 510 a method of accessing save area 230, e.g., information on the position of save area 230 in the hidden partition 120 and a password for access to the hidden partition 120 (S350). Receiving this information, the suspension portion 510 can save the state of execution of the main OS to the save area 230 in the hidden partition 120.

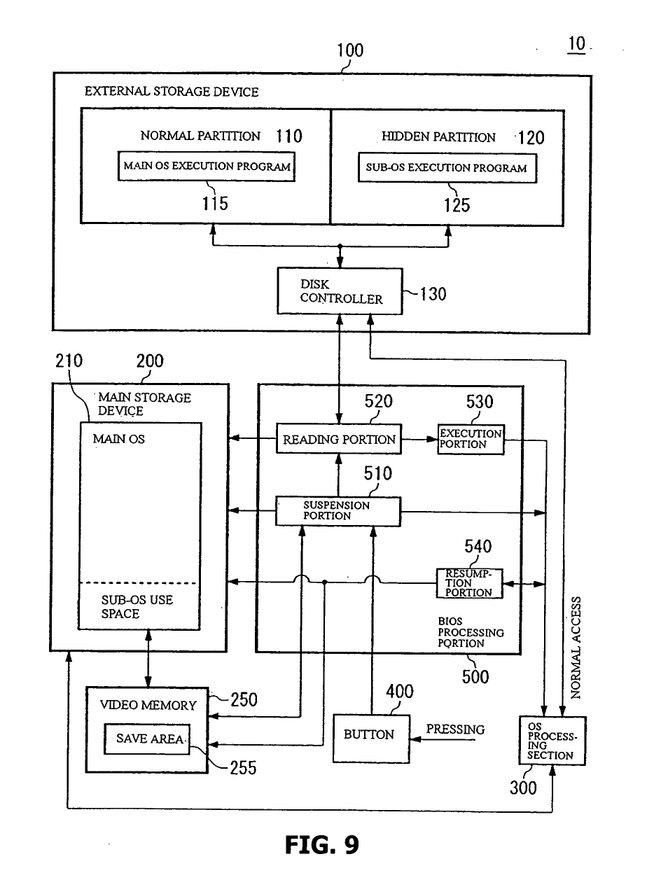

FIG. 9 is a functional block diagram of an information processing apparatus 10 in a third example of modification. The information processing apparatus 10 shown in FIG. 9 further has a video memory 250 in addition to the components of the information processing apparatus 10 shown in FIG. 1. Unlike the information processing apparatus 10 shown in FIG. 1, the information processing apparatus 10 shown in FIG. 9 may be formed without the device driver 220. The operation of the information processing apparatus 10 shown in FIG. 9 is substantially the same as that of the information processing apparatus 10 shown in FIG. 1, and description will be made with respect to points of difference only.

The video memory 250 is a memory used for on-screen display by the information processing apparatus 10. In this example of modification, the video memory 250 includes as a save area 255 an unused area not used by the sub-OS in the video memory 250.

When the suspension portion 510 receives a switching instruction from the button 400 and also receives an operation stop completion notification from the OS processing portion 300, it saves the state of execution of the main OS in the main storage unit 200 to the save area 255. The suspension portion 510 then sends to the reading portion 510 a readout instruction which is an instruction to read out the sub-OS when saving of the state of execution of the main OS is completed.

When the OS processing portion 300 receives from the suspension portion 510 an operation stop instruction to stop the operation of the main OS, it performs processing for stopping the operation of the main OS, i.e., processing for terminating programs necessary for the operation of the main OS, and sends to the suspension portion 510 an operation stop completion notice indicating the completion of suspension processing. The OS processing portion 300 may perform, for example, processing for saving the contents of the video memory onto the main storage device 200 as processing for stopping the operation of the main OS.

The OS processing portion 300 resumes the execution of the main OS restored in the main storage device 200 according to a main OS execution resumption instruction received from the resumption portion 540. The OS processing portion 300 may perform, for example, processing for returning to the video memory 250 the contents of the video memory 250 saved to the main storage device 200 before stoppage of the execution of the main OS as processing for resuming the execution of the main OS.

When the resumption portion 540 receives a sub-OS execution completion notice from the OS processing portion 300, it restores the state of execution of the main OS from the save area 255 into the main storage device 200, and sends a main OS execution resumption instruction to the OS processing portion 300.

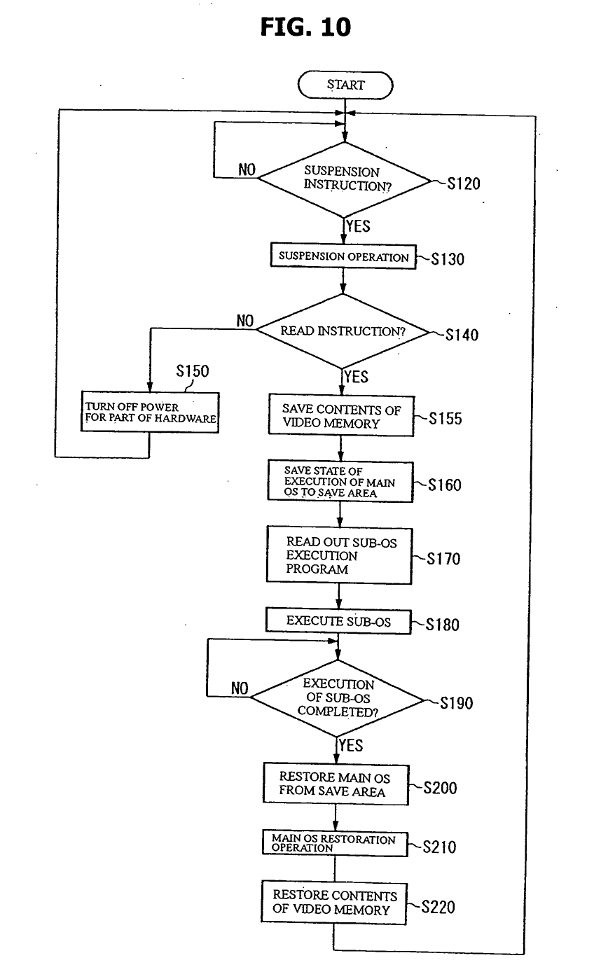

FIG. 10 shows in the flow of operation of the information processing apparatus 10 in the third example of modification. The flow of operation of the information processing apparatus 10 in this example of modification is substantially the same as the flow of operation of the information processing apparatus 10 shown in FIG. 2. Therefore description will be made with respect to different details of the operation. In this example, it is not necessary for the information processing apparatus 10 to secure the save area (S110).

When the suspension portion 510 receives a switching instruction including a readout instruction (S140: YES), the OS processing portion 300 saves the contents of the video memory 250 into the main storage device 200 (S155).

After performing the main OS restoration operation (S210), the OS processing portion 300 recovers the contents of the video memory 250 from the main storage device 200 (S220). Thereafter, the OS processing portion 300 can restore the on-screen display before the suspension by performing on-screen display updating processing.

Thus, in this example, the suspension portion 510 uses, as an area to which the state of execution of the main OS is saved, the video memory 250, which is an example of a storage area powered off to lose stored contents when the execution of the main OS is stopped and when the sub-OS is not started. It is therefore possible to omit processing for previously securing save area 255 before or during execution of the main OS.

The arrangement may be such that the information processing apparatus 10 may use, as well as the video memory 250, a predetermined area on the main storage device 200 or a storage area in input/output devices provided in the information processing apparatus 10.

While in this example the OS processing portion 300 saves the contents of the video memory 250 at the time of stoppage processing (S155), the arrangement may be such that processing for reducing the resolution of on-screen display is performed. For example, an ordinary frame of high resolution such as that for WINDOWS® may be changed to a frame of low resolution such as that in the DOS mode in WINDOWS®. In such a case, the suspension portion 510 uses as save area 255 an area in the video memory 250 which will not be used because the resolution of on-screen display is reduced. Before restoration of the main OS, the OS processing portion 300 returns the resolution of on-screen display to the state before stoppage and performs on-screen display updating processing to restore the on-screen display before suspension.

In such a case, the information processing apparatus 10 can perform switching to the sub-OS without saving the contents of the video memory 250 to the main storage device 200 or the like.

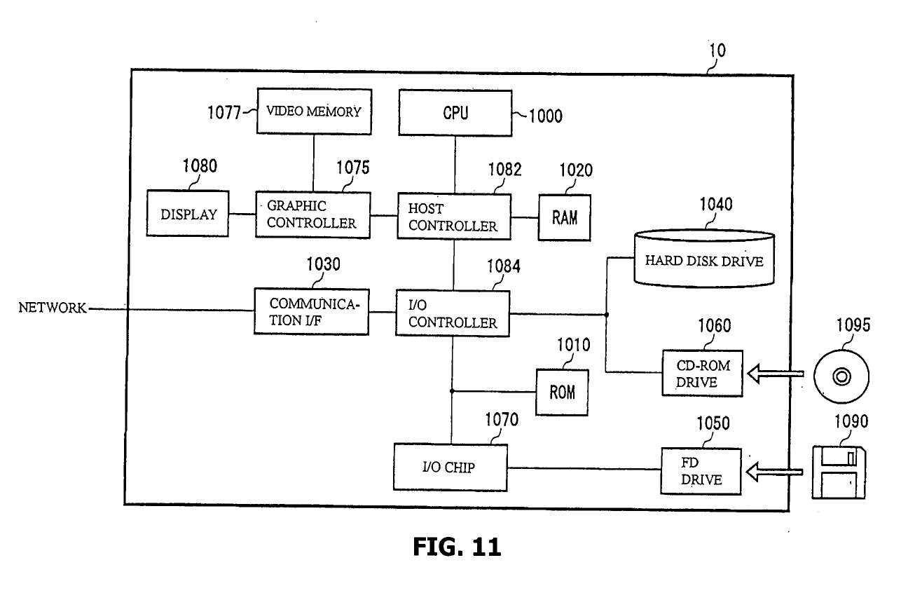

FIG. 11 shows an example of the hardware configuration of the information processing apparatus 10 in the embodiment of the present invention and the examples of modification. The information processing apparatus 10 in the embodiment is provided with a CPU peripheral having a CPU 1000, a RAM 1020, a graphic controller 1075 and a display 1080 connected to each other by a host controller 1082, an input/output portion having a communication interface 1030, a hard disk drive 1040 and a CD-ROM drive 1060 connected to the host controller 1082 by an input/output controller 1084, and a legacy input/output portion having a ROM 1010, a flexible disk drive 1050 and an input/output chip 1070 connected to the input/output controller 1084.

The host controller 1082 connects the RAM 1020, and the CPU 1000 and the graphic controller 1075 which access the RAM 1020 at a high transfer rate. The CPU 1000 operates on the basis of programs stored in the ROM 1010 and the RAM 1020 to control each portion. The graphic controller 1075 obtains image data produced on a frame buffer provided in the RAM 1020 by the CPU 1000 or the like, and displays the image data on the display 1080.

Alternatively, the graphic controller 1075 uses a video memory 1077 as a frame buffer in which image data produced by the CPU 1000 or the like is stored.

The input/output controller 1084 connects the host controller 1082 and comparatively high-speed input/output devices, i.e., the communication interface 1030, the hard disk drive 1040 and the CD-ROM drive 1060. The communication interface 1030 communicate with other units through a network.

The hard disk drive 1040 stores programs and data used by the information processing apparatus 10. The CD-ROM drive 1060 reads a program or data from a CD-ROM 1095 and provides the read program or data to the input/output chip 1070 via the RAM 1020.

To the input/output controller 1084, the ROM 1010 and comparatively low-speed input/output devices, i.e., the flexible disk drive 1050 and the input/output chip 1070 or the like, are connected. The ROM 1010 stores boot programs executed by CPU 1000 at the activation of the information processing apparatus 10, program dependent on the hardware of the information processing apparatus 10 and the like. For example, in the ROM 1010, a program by which the BIOS processing portion 500 in this embodiment is stored. The flexible disk drive 1050 reads a program or data from a flexible disk 1090 and provides the read program or data to the input/output chip 1070 via the RAM 1020. To the input/output chip 1070, flexible disk 1090 and various input/output devices are connected, for example, through a parallel port, a serial port, a keyboard port and a mouse port. The input/output chip 1070 receives data corresponding to an input made by a user and supplies the data to a program executed on the information processing apparatus 10.

A program provided to and executed by the information processing apparatus 10 has as its functional components a device driver, a suspension module, a read module, an execution module, a resumption module, an ACPI control module, and an OS processing module. The operation that each module performs through the information processing apparatus 10 is the same as the operation of the corresponding one of the components in the information processing apparatus 10 described above with reference to FIGS. 1 to 10, and description for it will not be repeated.

A program is provided to the information processing apparatus 10 in a state of being stored on a program recording medium such as flexible disk 1090, CD-ROM 1095 or an IC card by a user. The program is read out from the program recording medium and is executed by being installed in the information processing apparatus 10.

The above-described programs or modules may be stored on external storage mediums. As a storage medium, an optical recording medium such as DVD or PD, a magneto-optic recording medium such as MD, a tape medium, or a semiconductor memory such as an IC card may be used as well as flexible disk 1090 and CD-ROM 1095. Also, a storage device such as a hard disk or a RAM provided in a server system connected to a special-purpose communication network or the Internet may be used as a recording medium to provide a program to the information processing apparatus 10 via the network.

As described above, the information processing apparatus 10 stores the sub-OS execution program 125 in the hidden partition 120 hidden from the main OS to present the sub-OS execution program 125 from being broken by an inadvertent user operation or by a program with malicious intent during the operation of the main OS.

As described above, the information processing apparatus 10 can select and execute the main OS or the sub-OS according to the kind of information processing required by a user while stopping the operation of the main OS. For example, a user can select and execute the sub-OS having a shorter starting time in a case where information processing is performed with no need for high-performance functions of the main OS. Therefore the present invention is advantageous in terms of convenience.

In the drawings and specifications there has been set forth a preferred embodiment of the invention and, although specific terms are used, the description thus given uses terminology in a generic and descriptive sense only and not for purposes of limitation. Various modifications or changes can be made in the above-described embodiment without departing from the spirit of the invention. From the appended claims, it is apparent that cases in which such changes or modifications are made are also included within the scope of the present invention. For example, the information processing apparatus 10 may include all the features separately described as the embodiment as modified by the first to third examples given hereinabove.

We claim as our invention:

1. Apparatus, comprising:
an external storage device having a normal partition which can be referred to by a user and a hidden partition storing an executable program for an operating system and hidden from the user;
a reader which reads the executable program for the operating system from the hidden partition to a main storage unit in response to a direction for reading the program from the user; and
an execution unit which executes the operating system read into said main storage unit.

2 Apparatus of claim 1, wherein said reader transmits a predetermined password to said external storage device to permit said external storage device to read the hidden partition.

3. Apparatus of claim 1, wherein the operating system is a sub-operating system which is activated in a time period shorter than that required to activate a main operating system which runs in the apparatus when the user has not made the direction, and said reader reads the executable program for the sub-operating system from the hidden partition hidden from the main operating system.

4. Apparatus of claim 1, wherein the operating system is a sub-operating system having a power consumption per unit time lower than that of a main operating system which runs in the apparatus when the user has not made the direction, and said reader reads the executable program for the sub-operating system from the hidden partition hidden from the main operating system to said main storage device.

5. Apparatus of claim 1, wherein the operating system is a sub-operating system which is activated in a time period shorter than that required to activate a main operating system which runs in the apparatus when the user has not made the direction, said apparatus further comprising:
a suspend unit which stops the operation of the main operating system and saves the sate of execution of the main operating system to a save area when receiving a direction for suspension from the user during execution of the main operating system;
wherein said reader reads the executable program for the sub-operating system from the hidden partition to said main storage device when the direction for reading is received from the user in the suspended state after the direction for suspension has been received.

6. Apparatus of claim 5, wherein said suspend unit shifts the main operating system to the suspended state when receiving a switching direction for switching from the main operating system to the sub-operating system, and said reader reads the executable program for the sub-operating system to said main storage device by recognizing the reception of the direction for reading when the main operating system enters the suspended state.

7. Apparatus of claim 6, further comprising a resume unit which restores the state of execution of the main operating system from the save area and resumes the execution of the main operating system when the execution of the sub-operating system is completed.

8. Apparatus of claim 5, wherein said suspend unit saves the state of execution of the main operating system to the save area provided in the hidden partition.

9. Apparatus of claim 5, further comprising a device driver executed on the main operating system, said device driver requesting the main operating system to assign part of the main storage device as the save area; wherein said suspend unit saves the state of execution to the save area assigned by said device driver.

10. Apparatus of claim 5, wherein said suspend unit secures the save area in an NVS (Non-Volatile-Sleeping) area by using an ACPI function provided in the apparatus.

11. Apparatus of claim 5, wherein said suspend unit uses as the save area a video memory used for on-screen display by the apparatus.

12. Apparatus of claim 11, wherein said suspend unit uses as the save area an unused area not used by the sub-operating system in said video memory.

13. Apparatus of claim 5, wherein said suspend unit uses as the save area a storage area powered off to lose stored contents when the main operating system is in the suspended state and when the sub-operating system is not started.

14. A control method of controlling an apparatus having an external storage device having a normal partition which can be referred to by a user and a hidden partition hidden from the user, said method comprising the steps of:
previously storing an executable program for an operating system;
reading the executable program for the operating system from the hidden partition to a main storage unit in response to a direction for reading the program from the user; and
executing the operating system read into the main storage unit.

15. A product comprising:
a storage medium having a program stored therein which is readable by a computer having an external storage device which has a normal partition which can be referred to by a user and a hidden partition storing an executable program for an operating system and hidden from the user, said program causing the computer to function as:
a reader which reads the executable program for the operating system from the hidden partition to a main storage unit in response to a direction for reading the program from the user; and
an execution unit which executes the operating system read into the main storage unit.

16. A computer readable recording medium having recorded thereon a program for causing a computer to operate as an apparatus, the computer having an external storage device having a normal partition which can be referred to by a user and a hidden partition storing an executable program for an operating system and hidden from the user, the program causing the computer to function as:
a reader which reads the executable program for the operating system from the hidden partition to a main storage unit in response to a direction for reading the program from the user; and
an execution unit which executes the operating system read into the main storage unit.
